(19) United States
(12) Patent Application Publication
(10) Pub. No.: US 2026/0168594 A1
(43) Pub. Date: Jun. 18, 2026

(54) Ratchet O-Clamp Fixings

(71) Applicant: HellermannTyton Corporation, Milwaukee, WI (US)

(72) Inventors: Nathaniel Henry Karabon, Milwaukee, WI (US); Kenneth Van Hulst, Menomonee Falls, WI (US); James Spencer Teece, Cedarburg, WI (US); David G. Packard, Port Washington, WI (US)

(21) Appl. No.: 19/067,508

(22) Filed: Feb. 28, 2025

Related U.S. Application Data
(60) Provisional application No. 63/733,723, filed on Dec. 13, 2024.

(51) Int. Cl. F16L 3/10

(52) U.S. Cl. CPC F16L 3/1075

(57) ABSTRACT

Disclosed are fixings that are configured to position an object relative to a workpiece. In an aspect, a fixing includes a ratchet mechanism with first and second lock mechanisms. The first lock mechanism includes a band member that has a plurality of serrations. The second lock mechanism includes slotted opening and a pawl hingedly disposed in the slotted opening. The pawl further includes a primary pawl tooth on a first face that is configured to engage with a first serration of the plurality of serrations when the band member is inserted into the slotted opening in a first direction and a secondary pawl tooth on a second face that is configured to engage with a second serration of the plurality of serrations when the band member is moved in a second direction opposite the first direction to resist movement of the band member in the second direction.

### INCORPORATION BY REFERENCE

This application claims the benefit of U.S. Provisional Application No. 63/733,723, filed Dec. 13, 2024, the disclosure of which is incorporated herein by reference.

### SUMMARY

This document describes systems and fixing apparatuses (“ratchet O-clamp fixings”) that are configured to position (e.g., secure, attach) an object relative to a workpiece. In implementations, a ratchet O-clamp fixing (“fixing”) includes a ratchet mechanism that includes a first lock mechanism and a second lock mechanism. The first lock mechanism includes a band member that projects from the fixing. The band member includes a plurality of serrations that extend along a length of the band member and across a width of the band member. The second lock mechanism is configured to engage the first lock mechanism and includes a slotted opening in the fixing and a pawl hingedly disposed in the slotted opening. The pawl includes a first face that defines a first face plane and a second face that defines a second face plane. The second face plane is different than the first face plane. The pawl further includes a primary pawl tooth on the first face, which is configured to engage with a first serration of the plurality of serrations when the band member is inserted into the slotted opening in a first direction. The pawl also includes a secondary pawl tooth on the second face, which is configured to engage with a second serration of the plurality of serrations when the band member is moved in a second direction opposite the first direction to resist movement of the band member in the second direction.

This Summary is provided to introduce simplified concepts of ratchet O-clamp fixings, which are further described below in the Detailed Description and are illustrated in the Drawings. This Summary is not intended to identify essential features of the claimed subject matter, nor is it intended for use in determining the scope of the claimed subject matter.

### BRIEF DESCRIPTION OF THE DRAWINGS

The details of one or more implementations of systems and fixing apparatuses (e.g., ratchet O-clamp fixings) are described with reference to the following Drawings.

FIG. 1A is a left side view of a ratchet O-clamp fixing, which illustrates an open position.

FIG. 1B is a partial view of the ratchet O-clamp fixing of FIG. 1A.

FIG. 1C is a perspective view of the ratchet O-clamp fixing of FIG. 1A.

FIG. 1D is a left side view of the ratchet O-clamp fixing of FIG. 1A, which illustrates a closed position.

FIG. 1E is a perspective view of the ratchet O-clamp fixing of FIG. 1D.

FIG. 2A is a schematic illustration of a first engagement of a pawl with a band.

FIG. 2B is a schematic illustration of a second engagement of a pawl with a band.

FIG. 3 is a perspective view of another ratchet O-clamp fixing, which illustrates an open position.

FIG. 4 is a perspective view of an additional ratchet O-clamp fixing, which illustrates an open position.

### DETAILED DESCRIPTION

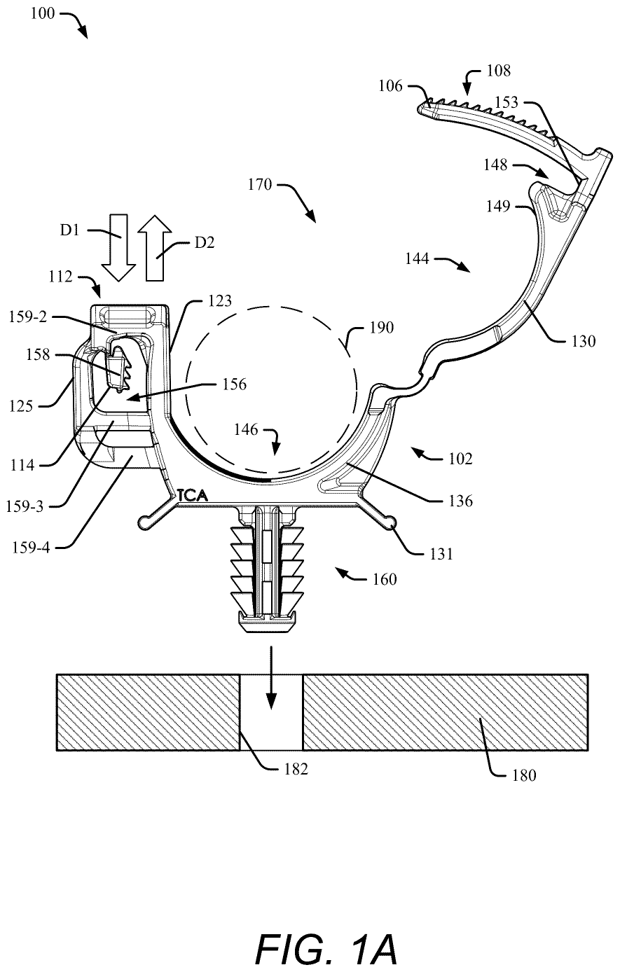

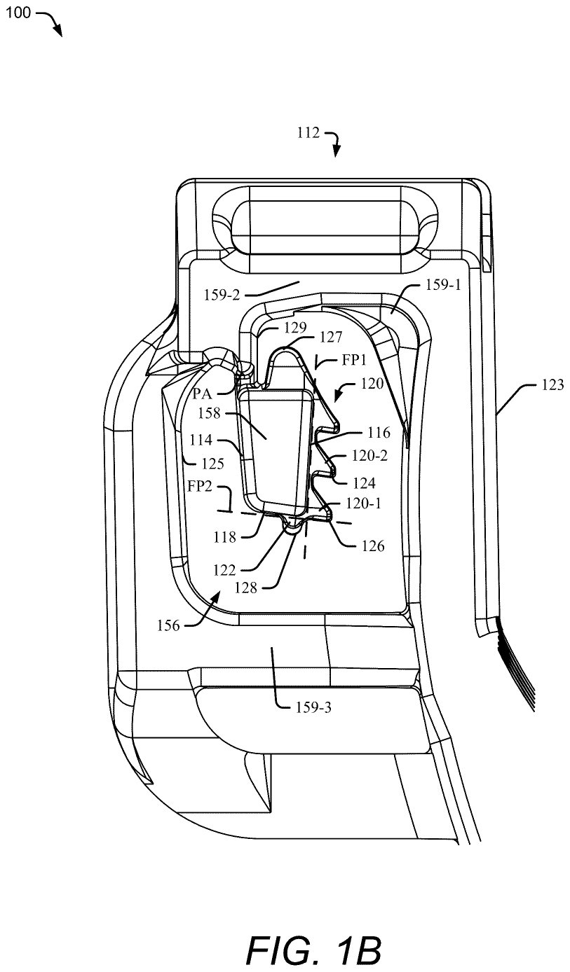

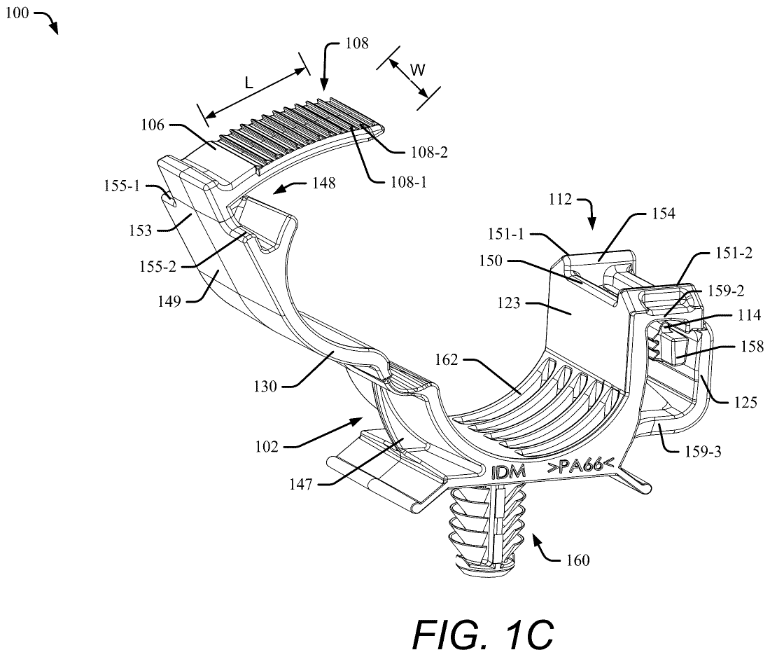

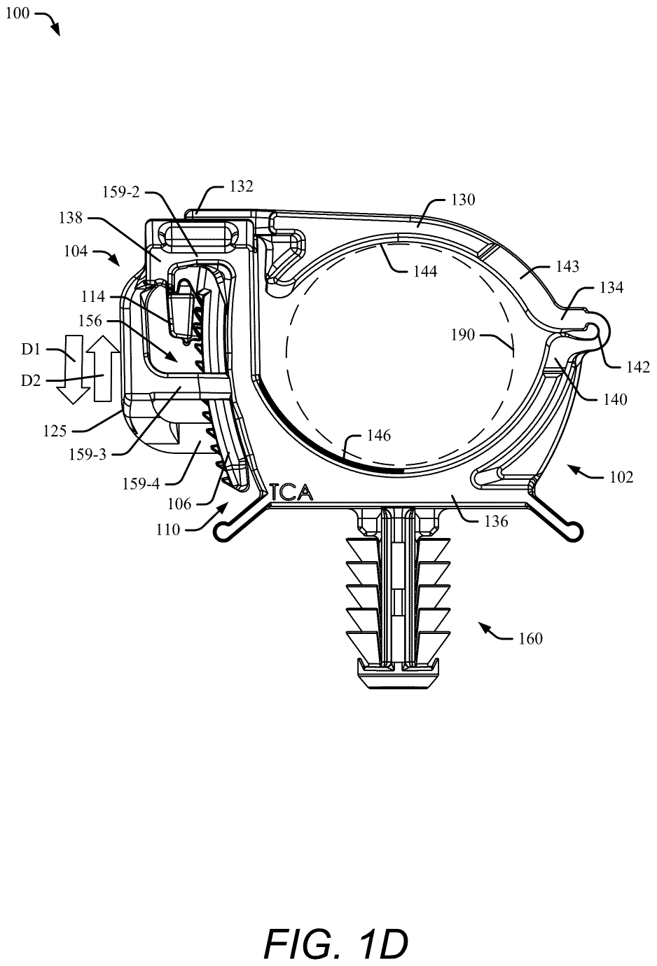

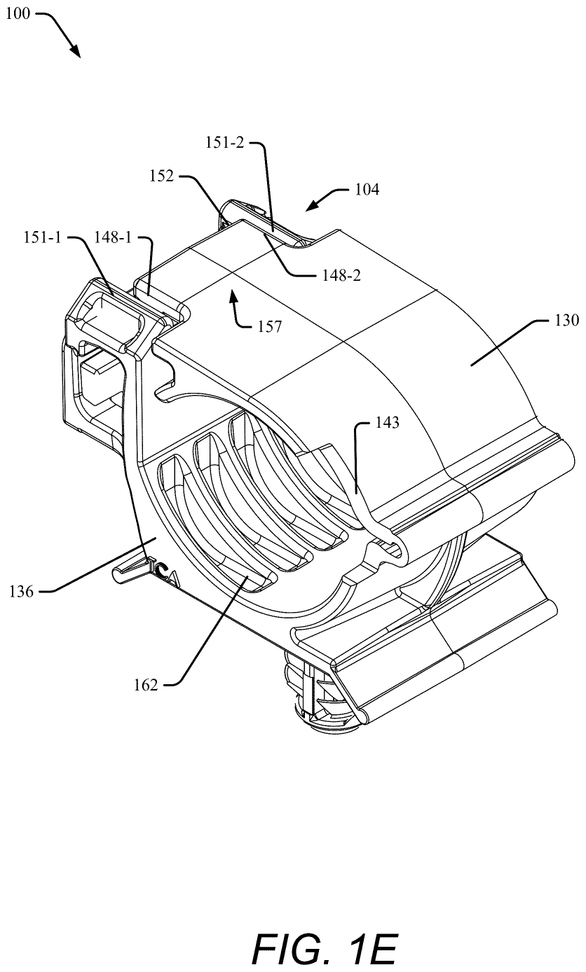

This Detailed Description of example implementations of ratchet O-clamp fixings refers to the accompanying Drawings. In this Description, the same reference numbers in different Drawings may identify the same or similar features, elements, and/or components. The first digit(s) of a call-out number may correlate with the first figure number in which the call-out number is labeled. For example, call-out numbers that start with a 1 (e.g., slotted opening 112, pawl 114) may represent details that are first called out with respect to FIGS. 1A-1E. The implementations described are configured to position one or more objects relative to a workpiece. For example, a user (e.g., an installer) may use a fixing to attach a component to a machinery frame at a desired location. A ratchet O-clamp fixing is one example of a fixing that is configured to position an object relative to a workpiece.

FIGS. 1A-1E illustrate an example ratchet O-clamp fixing (“fixing”) that is configured to position an object relative to a workpiece. The fixing 100 includes a body section 102 (e.g., a body 102) that includes a mount section 160 and/or an object support 170.

The mount section 160 is configured to mount (e.g., connect) the fixing 100 to a workpiece 180. The term “workpiece,” as used herein, includes machines, cabinets, housings, frames, enclosures, vehicle chassis, panels, rails, support beams, cable routing channels, conveyor channel assemblies, frame rails, and the like, unless the context indicates otherwise. The mount section 160 may include a connector. The connector may include any common connection manner, including, but not limited to, a fastener (e.g., a blind hole fastener, a clamp fastener, a mechanical fastener, a T-nut fastener for a T-slot metal frame, an arrowhead fastener, a fir-tree fastener, a mounting edge clip, a twist-lock fastener configured for receipt into the slot of a rail, a weld stud mount, a cable attachment, a hose attachment), an adhesive fastener (e.g., double-sided adhesive tape), a magnet, a friction fit, and the like, and combinations thereof. The mount section 160 may include a fastener configured to engage a mount aperture (e.g., a slot, a channel, a bore) defined in the workpiece; a connector configured to engage an elongated fastener that extends from the workpiece (e.g., a stud, a threaded bolt); a clamp portion configured to clamp onto the edge of the workpiece; and the like. The mount section 160 may include mounting features molded into the body 102. In FIGS. 1A-1E, the mount section 160 is a fir-tree fastener configured for insertion into an orifice 182 defined in the workpiece 180 (e.g., a panel). The mount section 160 may connect to the body 102 at least one of a first clamp member 130 or a second clamp member 136.

The object support 170 is configured to support the object 190 relative to the workpiece 180. The term “object,” as used herein, includes components, elongated articles, wires, hoses, tubes, cables, conduit, and the like, and bundles thereof, unless the context indicates otherwise. Examples of object supports include, but are not limited to, clamps (e.g., routing clamps, bracket clamps), clips (e.g., flip fasteners, routing clips, bundling clips, connector clips, United States Council for Automotive Research (USCAR) connector clips, USCAR connector clip slots), mounts (e.g., swivel mounts, stud mounts), custom brackets, and the like. An object support 170 may include one or more cable ties used to bundle the component and/or to hold a bundle of one or more components to the object support 170. In FIGS. 1A and 1D, the object 190 is illustrated as a dashed circle that represents a bundle (e.g., of cables).

In the aspect of FIGS. 1A-1E, the fixing 100 is a ratchet O-clamp fixing that includes a ratchet mechanism 104 (aka a “ratchet clamp mechanism”), illustrated in FIG. 1D. The ratchet mechanism 104 includes a first lock mechanism and a second lock mechanism, which are configured to engage one another to secure the object 190 therein. In this way, the first lock mechanism and the second lock mechanism may operate as a ratchet closure that clicks together as they close around the object 190. The first lock mechanism includes a band member 106 that projects from the fixing 100. The band member 106 includes a plurality of serrations 108 that extend along a length (L) of the band member 106 and across a width (W) of the band member 106, as illustrated in FIG. 1C. The second lock mechanism includes a slotted opening 112 in the body 102 of the fixing 100 and a pawl 114 that is hingedly disposed in the slotted opening 112.

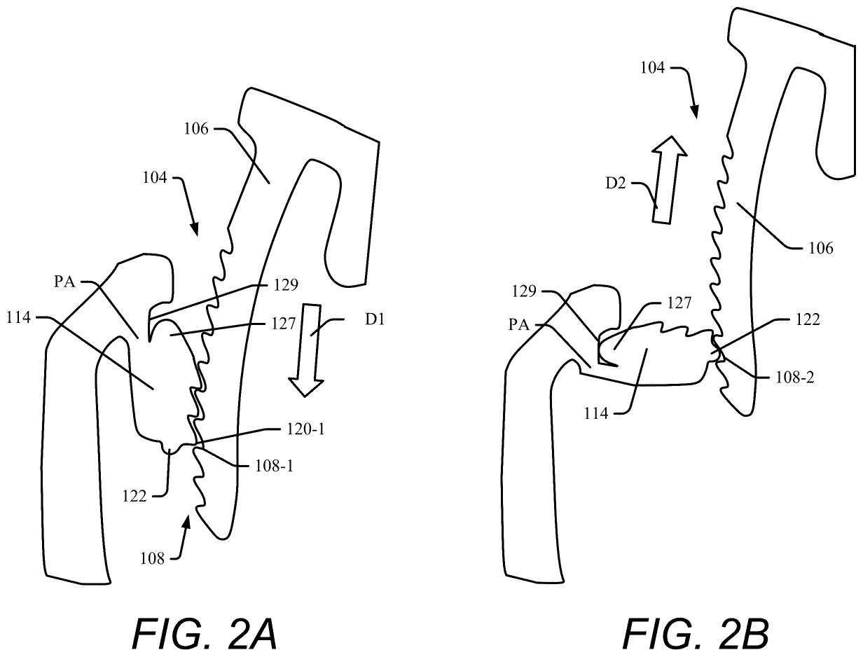

As illustrated in FIGS. 1B, 2A, and 2B, the pawl 114 includes a first face 116 that defines a first face plane (FP1) and a second face 118 that defines a second face plane (FP2). The second face plane (FP2) is a different plane than the first face plane (FP1). In some aspects, the second face plane (FP2) is oblique to the first face plane (FP1) and in other aspects the second face plane (FP2) is generally orthogonal to the first face plane (FP1).

The pawl 114 includes at least one primary pawl tooth 120 on the first face 116. The primary pawl tooth 120 (e.g., first primary pawl tooth 120-1) is configured to engage with a first serration (e.g., first serration 108-1) of the plurality of serrations 108 when the band member 106 is inserted into the slotted opening 112 in a first direction (D1), as illustrated in FIG. 1D and FIG. 2A. As the band member 106 is inserted in the first direction, the teeth ratchet relative to the serrations.

The pawl 114 further includes at least one secondary pawl tooth 122 on the second face 118. The secondary pawl tooth 122 is configured to engage with a second serration 108-2 of the plurality of serrations 108 when the band member 106 is moved in a second direction (D2) that is opposite to the first direction (D1) to resist movement of the band member 106 in the second direction (D2). In this way, the secondary pawl tooth 122 may improve bundle retention strength when the fixing 100 experiences full loading. The pawl 114 is configured to pivot about a pivot axis (PA) to enable a tail 127 of the pawl 114 contact a hinge support surface 129 (e.g., a front wall ledge) to cam the secondary pawl tooth 122 against the second serration 108-2 when the band member 106 is moved in the second direction (D2), as illustrated in FIG. 2B, which may happen when a load is present on or within the clamp of the fixing 100. In one example, a load is present when the hose is circumferentially-restrained hose that carries pressurized gas and an increase in temperature causes the diameter of the hose to increase. In another example, a load is present when the hose is circumferentially-restrained hydraulic hose that is exposed to a pulsating movement caused by hydraulic pump pressure fluctuations. In the configuration illustrated in FIG. 2B, the pawl 114 wedges the band member 106 in the slotted opening 112. The tail 127 may include at least one heel that is configured to contact, compress, and/or pivot against the hinge support surface 129.

In aspects, the at least one primary pawl tooth 120 on the first face 116 includes a first primary pawl tooth 120-1 on the first face 116 and a second primary pawl tooth 120-2 on the first face 116. Additional primary pawl teeth may be present. The first primary pawl tooth 120-1 includes a first point 126 and the second primary pawl tooth 120-2 includes a second point 124. The at least one secondary pawl tooth 122 on the second face 118 includes a third point 128. In aspects, the second point 124 is located between the first point 126 and the third point 128, the first point 126 and the second point 124 are equally spaced apart, and the second point 124 and the third point 128 are equally spaced apart.

The second lock mechanism may further include a port 156 (e.g., defined in the body 102) that is configured to provide user access to a release mechanism 158 (“release tab”) that is configured to release the engagement of the pawl 114 with the band member 106 to manually disengage the pawl 114 from the serrations 108 of the band member 106. The release mechanism 158 may include at least one tab that extends from the pawl 114, which may be accessible from the first and/or second side of the ratchet mechanism 104.

The port 156 may be defined by one or more cage pillars (e.g., upper cage pillar 159-1, upper cage pillar 159-2, lower cage pillar 159-3, lower cage pillar 159-4) that extend from the body 102 around the slotted opening 112. In aspects, the cage pillars may structurally join a front wall portion 125 and a back wall portion 123 of the slotted opening 112 together. The back wall portion 123 may be opposite the front wall portion 125. In FIGS. 1A-1E, the upper cage pillar 159-1 and the upper cage pillar 159-2 are illustrated as parallel to one another, and lower cage pillar 159-3 and lower cage pillar 159-4 are illustrated as offset from one another. The cage pillars may prevent engaged band serrations from sliding out of engagement with pawl teeth, may create a tight band passage, and may facilitate consistent engagement of band serrations to pawl teeth.

The slotted opening 112 includes a first sidewall 152 opposite a second sidewall 154. The first and second sidewalls are configured to receive the band member 106 therebetween and limit lateral movement of the band member 106 to prevent the serrations 108 of the band member 106 from sliding out of engagement with at least one primary pawl tooth 120 of the pawl 114.

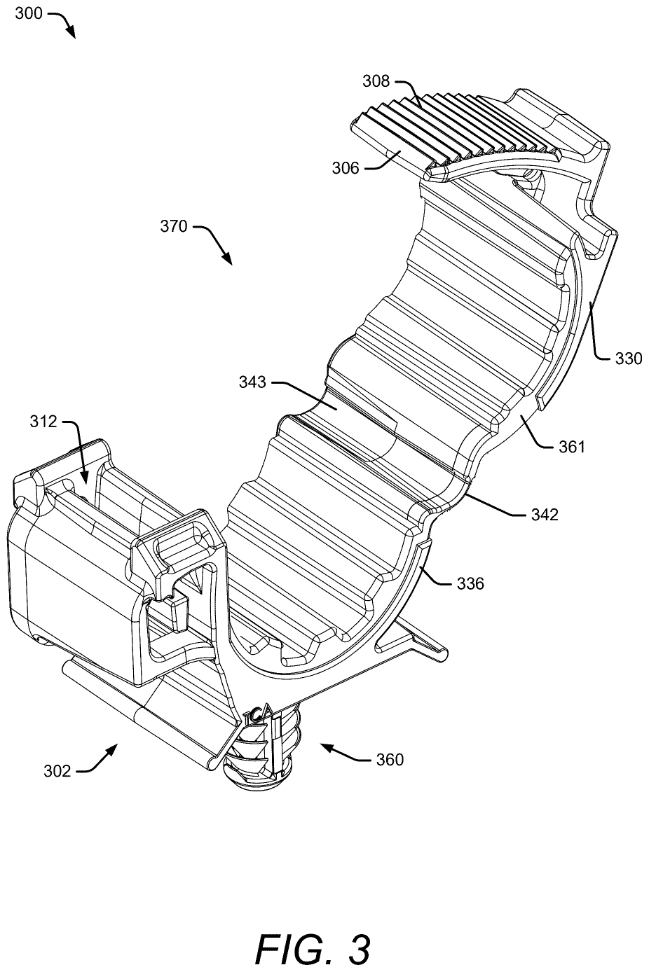

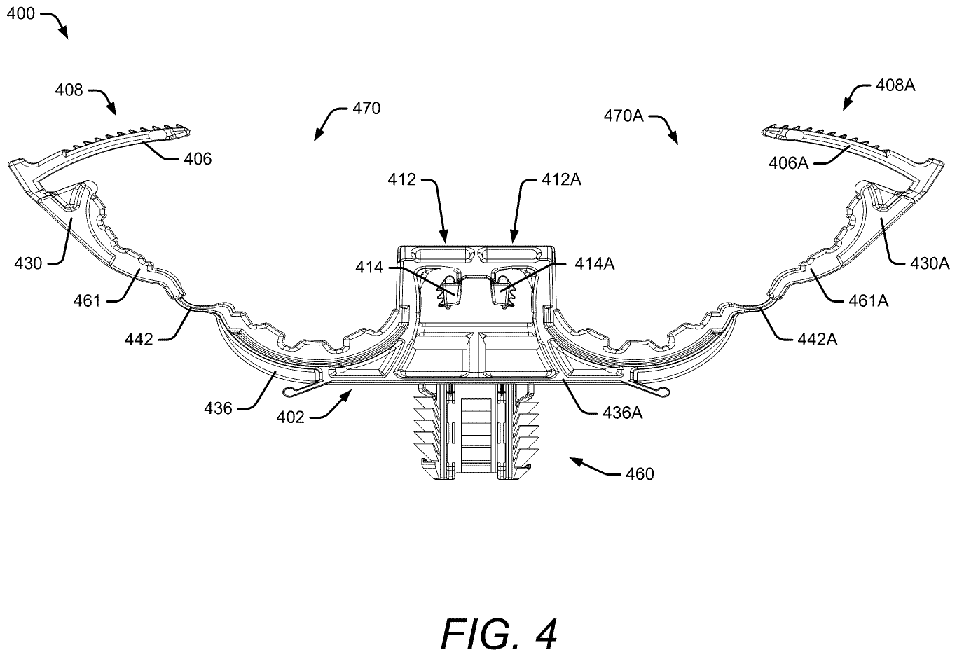

The object support 170 of the fixing 100 includes a first clamp member 130 and a second clamp member 136. The first clamp member 130 includes a first end 132 opposite a second end 134. The second clamp member 136 includes a first end 138 opposite a second end 140. The first clamp member 130 includes the first lock mechanism and the second clamp member 136 includes the second lock mechanism. The second lock mechanism is configured to engage the first lock mechanism to releasably lock a position of the first end 132 of the first clamp member 130 relative to a position of the first end 138 of the second clamp member 136 and around the object 190, with the object 190 located in a passageway defined between the first and second clamp members. The first clamp member 130 may include a first arcuately-shaped portion 144 and the second clamp member 136 may include a second arcuately-shaped portion 146. The first and second arcuately-shaped portions may define the passageway, which is configured to receive the object 190. At least one of the first arcuately-shaped portion 144 or the second arcuately-shaped portion 146 may define one or more interior ribs 162, as illustrated in FIGS. 1C and 1E. The interior ribs 162 may be convoluted ribs, which are molded into the clamp member. The interior ribs 162 may be configured to engage the object 190 to minimize vibration-induced movement of the object 190 held in the fixing 100. In aspects, the interior ribs 162 provide for cored-out material reduction, control sinking, and/or control warpage. In aspects (e.g., FIG. 3, FIG. 4), the interior ribs may be overmolded with an elastic material.

The first clamp member 130 includes an open channel portion 148 that is defined between the band member 106 and a body member 149 of the first clamp member 130. In aspects, the open channel portion 148 is configured to receive a back wall 150 of the second clamp member 136 to interlock the first clamp member 130 to the second clamp member 136 when the first lock mechanism engages the second lock mechanism, as illustrated in FIGS. 1D and 1E.

The band member 106 extends from the body member 149 via an extension portion 153, as illustrated in FIGS. 1A and 1C. The extension portion 153 defines at least one notch (notch 155-1, notch 155-2) that is configured for receipt between top wall portions (top wall portion 151-1, top wall portion 151-2) of the second clamp member 136. The top wall portions may define a pawl cage support guide that helps prevent the band member 106 from twisting and may provide additional support around the pawl 114 for better retention strength. Extension portion 153 defines a cover 157 that is configured to recess into and/or nest inside the top wall portions (top wall portion 151-1, top wall portion 151-2) for a lower profile (cover closed height), as illustrated in FIGS. 1D and 1E. In this way, the fixing 100 may provide a low-profile installed height on smaller bundle sizes.

The fixing 100 includes a hinge portion 142 that hingedly connects the second end 134 of the first clamp member 130 to the second end 140 of the second clamp member 136. The hinge portion 142 may include a flow path portion 143 that is configured to receive elastic material, for example, as is illustrated in FIG. 3 and described below. The body 102 may include a structural rib 147 that is configured to strengthen the area under the hinge portion 142. The body 102 may include a spring flange 131. The spring flange 131 may extend from the side of the body 102 that includes the mount section 160. The spring flange 131 configured to engage the workpiece 180.

The fixing 100 and/or one or more of the components (e.g., body 102, mount section 160, object support 170) of the fixing 100 may be integrally formed of a suitable material(s) (e.g., a polymeric material) through one or more of an injection-molding process, an additive manufacturing process (e.g., a fused deposition modeling (FDM) process, a three-dimensional (3D) printing process), or another suitable process.

Referring now to FIG. 3, another aspect of a fixing 300 is illustrated. The fixing 300 is similar to the fixing 100 illustrated in FIGS. 1A-1E and described above, except as detailed below. Thus, the fixing 300 includes a body 302, a ratchet mechanism, a band member 306, serrations 308, a slotted opening 312, a pawl, a first face, a second face, a primary pawl tooth, a secondary pawl tooth, a back wall portion, a first point, a front wall portion, a second point, a tail, a third point, a first clamp member 330, a spring flange, a second clamp member 336, a hinge portion 342, a flow path portion 343, a first arcuately-shaped portion, a second arcuately-shaped portion, a release mechanism, a mount section 360, an object support 370, and the like.

The fixing 300 and/or one or more of the components (e.g., body 302, mount section 360, object support 370) of the fixing 300 may be integrally formed of a suitable material(s) (e.g., a polymeric material) through one or more of an injection-molding process, an additive manufacturing process (e.g., a fused deposition modeling (FDM) process, a three-dimensional (3D) printing process), or another suitable process. At least a portion of the polymeric material of the fixing 300 may be overmolded with a liner 361 formed of an elastic material (e.g., a thermoplastic elastomer (TPE) material). The fixing 300 may include interior ribs (e.g., interior ribs 162 of FIG. 1), which are overmolded with the elastic material of the liner 361.

The hinge portion 342 may include a flow path portion 343 that is configured to receive elastic material. In aspects, the flow path portion 343 is a notched portion defined in the hinge portion 342 that is configured as a flow path for receipt of the elastic material that is overmolded onto the first clamp member 330, second clamp member 336, and/or the hinge portion 342. A flow path portion is also illustrated in FIG. 1E as flow path portion 143. The flow path portion 343 may allow one gate location (e.g., a single flow path) to fill in all the elastic material features in the mold, which may result in reduced cost. The flow path portion 343 may be formed in line with the hinge portion 342, so as to not alter or restrict flexibility of the hinge portion 342. The flow path portion 343 may not span the full depth and thickness of the hinge portion 342, which may minimize the thickness of the hinge portion 342, preserve the flexibility of the hinge portion 342, and/or maintain the range of motion of the hinge portion 342 in contrast to a fixing that includes an elastic material that covers the entire hinge portion.

A known fabrication technique (e.g., an overmolding process) may be utilized to form a connection between the body 302 and/or object support 370) of the fixing 300 and the liner 361. In an example overmolding process, an elastic material is injected into a mold cavity into which at least a portion of a non-elastic substrate (e.g., first clamp member 130, second clamp member 136, hinge portion 142) is positioned, and the elastic material is overmolded over at least a portion of the non-elastic substrate. As used herein, the phrases “overmolded with” and “overmolded over” includes overmolding onto and/or overmolding into. The overmolding process may be a multi-material molding process (e.g., a multi-shot injection molding process) where the non-elastic substrate is molded first, the injection molding cavity of the substrate mold is altered or the substrate is moved to a second mold, and the elastic material is injected into the mold to bond to at least a portion of the substrate and form the fixing. Through the overmolding process, the elastic material may chemically bond to the non-elastic material.

Referring now to FIG. 4, another aspect of a fixing 400 is illustrated, which includes multiple object supports in a double-clamp configuration. The fixing 400 is similar to the fixing 100 illustrated in FIGS. 1A-1E and described above, except as detailed below. Thus, the fixing 400 includes a body 402, a ratchet mechanism, a band member 406, serrations 408, a slotted opening 412, a pawl 414, a first face, a second face, a primary pawl tooth, a secondary pawl tooth, a back wall portion, a first point, a front wall portion, a second point, a tail, a third point, a first clamp member 430, a spring flange, a second clamp member 436, a hinge portion 442, a flow path portion, a first arcuately-shaped portion, a second arcuately-shaped portion, a release mechanism, a mount section 460, an object support 470, and the like. The fixing includes a second object support 470A, which includes a ratchet mechanism, a band member 406A, serrations 408A, a slotted opening 412A, a pawl 414A, a first clamp member 430A, a second clamp member 436A, a hinge portion 442A, and the like.

The fixing 400 and/or one or more of the components (e.g., body 402, mount section 460, object support 470, object support 470A) of the fixing 400 may be integrally formed of a suitable material(s) (e.g., a polymeric material) through one or more of an injection-molding process, an additive manufacturing process (e.g., a fused deposition modeling (FDM) process, a three-dimensional (3D) printing process), or another suitable process. At least a portion of the polymeric material of the fixing 400 may be overmolded with a liner (e.g., liner 461, liner 461A) formed of an elastic material (e.g., a thermoplastic elastomer (TPE) material). The fixing 400 may include interior ribs (e.g., interior ribs 162 of FIG. 1), which are overmolded with the elastic material of the liner.

A fixing (e.g., fixing 100, fixing 300, fixing 400) and/or one or more of the components (e.g., body, mount section, object support) of the fixing may be integrally formed of a suitable material, including, but not limited to, a metal, a ceramic, a polymer (e.g., a polymeric material), and/or a composite. Suitable polymeric materials may include one or more of polyamide (PA), polypropylene (PP), polyethylene (PE), polyphenylene sulfide (PPS), polyether ether ketone (PEEK), polyaryletherketone (PAEK), ethylene tetrafluoroethylene (ETFE), polyacetal (POM), polybutylene terephthalate (PBT), ultraviolet stabilized polyacetal (POMUV), ASA acrylonitrile styrene acrylate, cross-linked thermoplastics, partially cross-linked thermoplastics, higher-temperature resins, ultraviolet (UV) resistant resins, other thermoplastic materials, and the like, and copolymers, blends, or alloys thereof)) as well as fiber reinforced materials. A suitable polymeric material may include one or more additives (e.g., heat stabilizers (e.g., copper iodide), impact modifiers (e.g., polyolefin, urethane, rubber), UV stabilizers (e.g., carbon black, hindered amine light stabilizers (HALS)), flame retardants (e.g., nitrogen-based halogen-free flame retardants, melamine cyanurate, melamine borate, ammonium polyphosphate), colorants, and the like). One or more of the components of the disclosed fixings may be formed of the same material as the other components, or of a different material than the other components.

A fixing (e.g., fixing 100, fixing 300, fixing 400) and/or one or more of the components (e.g., body, mount section, object support) of a fixing disclosed herein may include an elastic material. The term “elastic,” as used herein, means a material (e.g., an “elastic material”) that exhibits recovery from deformation (e.g., stretching, compression) in at least one direction, unless the context indicates otherwise. For example, elastic may refer to a material that, upon application of a compressive force, is deformable from an original relaxed length and that will recover to the original relaxed length upon release of the compressive force. An elastic material may be a thermoplastic elastomeric high-stretch material (e.g., a thermoplastic high-stretch elastomer). Examples of elastic materials for fixings disclosed herein include, but are not limited to, butyl rubber, ethylene propylene diene monomer (EPDM) rubber, polyisoprene, neoprene, fluoroelastomer, ethylene propylene rubber (EPR), ethylene-vinyl acetate (EVA), poly(acrylic acid) (PAA), latex, natural latex rubber, polyurethane, nitrile rubber, acrylonitrile butadiene rubber, styrene butadiene, styrene-butadiene rubber (SBR), silicone rubber, polybutadiene, thermoplastic elastomers (TPE) (e.g., thermoplastic rubbers, styrenic block copolymers (thermoplastic styrenics) (TPS), thermoplastic polyolefinelastomers (thermoplastic olefin) (TPO), thermoplastic vulcanizates (TPV), thermoplastic polyurethanes (TPU), thermoplastic urethane, thermoplastic copolyester (TPC) (e.g., thermoplastic polyester elastomers (TPC ET)), thermoplastic polyamides (TPA), styrene ethylene butadiene styrene (SEBS), and the like), poly(styrene butadiene styrene) (SBS), polybutylene terephthalate (PBT) and polytetramethylene glycol (PTMG) copolymer, synthetic rubber, foam rubber, silicone rubber, urethane, elastomer, other rubber-like materials, and the like, and copolymers, blends, and alloys thereof. As used herein, the term “non-elastic” means any material (e.g., a “non-elastic material”) that does not fall within the definition of “elastic” above.

In this description, ordinal numbers such as “first” and “second” are used only to distinguish between different described objects, and have no limitation on a location, a sequence, a priority, a quantity, content, or the like of the described objects. For example, a “first lock mechanism” is used as an example, and there may be one or more “lock mechanisms.” Additionally, objects modified by different ordinal numbers may be the same or different objects. For example, if the described object is an “serration,” a “first serration” and a “second serration” may be the same or different serrations.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

In aspects, systems and fixing apparatuses (e.g., ratchet O-clamp fixings) that are configured to position an object relative to a workpiece may include one or more of the features illustrated in the Drawings and described above. Although implementations for ratchet O-clamp fixings have been described in language specific to certain features and/or methods, the subject of the appended claims is not necessarily limited to the specific features or methods described. Rather, the specific features and methods are disclosed as example implementations of ratchet O-clamp fixings.

What is claimed is:

1. A fixing comprising:
a ratchet mechanism comprising:
a first lock mechanism comprising:
a band member that projects from the fixing, the band member comprising:
a plurality of serrations that extend along a length of the band member and across a width of the band member;
a second lock mechanism configured to engage the first lock mechanism, the second lock mechanism comprising:
a slotted opening in the fixing; and
a pawl hingedly disposed in the slotted opening, the pawl comprising:
a first face that defines a first face plane;
a second face that defines a second face plane, the second face plane different than the first face plane;
at least one primary pawl tooth on the first face, the primary pawl tooth configured to engage with a first serration of the plurality of serrations when the band member is inserted into the slotted opening in a first direction; and
at least one secondary pawl tooth on the second face, the secondary pawl tooth configured to engage with a second serration of the plurality of serrations when the band member is moved in a second direction opposite the first direction to resist movement of the band member in the second direction.

2. The fixing of claim 1, wherein the at least one primary pawl tooth on the first face further comprises:
a first primary pawl tooth on the first face, the first primary pawl tooth comprising a first point; and
a second primary pawl tooth on the first face, the second primary pawl tooth comprising a second point.

3. The fixing of claim 2,
wherein the at least one secondary pawl tooth on the second face comprises a third point,
wherein the first point is located between the second point and the third point,
wherein the first point and the second point are equally spaced apart, and
wherein the first point and the third point are equally spaced apart.

4. The fixing of claim 2, wherein the second face plane is generally orthogonal to the first face plane.

5. The fixing of claim 2,
wherein the slotted opening includes a front wall portion, and
wherein the pawl is configured to pivot about a pivot axis to enable a tail of the pawl contact the front wall portion to cam the secondary pawl tooth against the second serration when the band member is moved in the second direction.

6. The fixing of claim 5, wherein the tail of the pawl is configured to contact a hinge support surface of the front wall portion to cam the secondary pawl tooth against the second serration when the band member is moved in the second direction.

7. The fixing of claim 6, wherein the tail further comprises at least one heel that is configured to contact, compress, and/or pivot against the hinge support surface.

8. The fixing of claim 1, further comprising:
a first clamp member comprising a first end opposite a second end, the first clamp member including the first lock mechanism;
a second clamp member comprising a first end opposite a second end, the second clamp member including the second lock mechanism, the second lock mechanism is configured to engage the first lock mechanism to releasably lock a position of the first end of the first clamp member relative to a position of the first end of the second clamp member and around an object; and
a hinge portion that hingedly connects the second end of the first clamp member to the second end of the second clamp member.

9. The fixing of claim 8, wherein the first clamp member includes a first arcuately-shaped portion and the second clamp member includes a second arcuately-shaped portion, the first and second arcuately-shaped portions configured to receive the object.

10. The fixing of claim 9, wherein at least one of the first arcuately-shaped portion or the second arcuately-shaped portion defines at least one interior rib that is configured to engage the object.

11. The fixing of claim 8, wherein the first clamp member includes an open channel portion defined between the band member and a body of the first clamp member, the open channel portion configured to receive a back wall of the second clamp member to interlock the first clamp member to the second clamp member when the first lock mechanism engages the second lock mechanism.

12. The fixing of claim 8, further comprising:
a mount section connected to at least one of the first clamp member or the second clamp member, the mount section configured to connect to a workpiece.

13. The fixing of claim 12, wherein the mount section comprises at least one of a clamp, clip, clip fastener, fir tree fastener, swivel mount, USCAR connector clip slot, USCAR connector clip, or a stud mount.

14. The fixing of claim 1, wherein the slotted opening includes a first sidewall opposite a second sidewall, the first and second sidewalls configured to receive the band member therebetween and limit lateral movement of the band member to prevent the serrations of the band member from sliding out of engagement with at least one primary pawl tooth of the pawl.

15. The fixing of claim 1, wherein the fixing comprises a polymeric material.

16. The fixing of claim 15, wherein at least a portion of the polymeric material of the fixing is overmolded with an elastic liner.

17. The fixing of claim 16, wherein the elastic liner is a thermoplastic elastomer (TPE) liner.

18. The fixing of claim 1, wherein the second lock mechanism further comprises a port configured to provide access to manually disengage the pawl from the serrations of the band member.

19. The fixing of claim 1, wherein the pawl further comprises a release mechanism that is configured to disengage the pawl from the serrations of the band member, wherein the release mechanism is accessible through a port defined in a body of the first clamp member.
